(19) United States
(12) Patent Application Publication
(10) Pub. No.: US 2019/0111828 A1
(43) Pub. Date: Apr. 18, 2019

(54) Slide-out assemblies for recreational vehicles

(71) Applicant: John Rhymer, South Bend, IN (US)

(72) Inventor: John Rhymer, South Bend, IN (US)

(21) Appl. No.: 15/932,444

(22) Filed: May 17, 2017

(51) Int. Cl. B60P 3/34

(52) U.S. Cl. CPC B60P 3/34

(57) ABSTRACT

Slide-out assemblies for recreational vehicles are provided where the slide-out assembly has a non-rectangular floor, with one side wall of the slide-out assembly which can be extended outward further from the vehicle than the other side wall, and wherein the movement of the slide-out assembly into and out of the RV includes pivotal motion and/or motion along a non-linear path. In addition, slide-out assemblies according to the present invention include a curved roofline to facilitate fluid run off.

### BACKGROUND OF THE INVENTION

The present invention relates to recreational vehicles (“RVs”), and, more particularly, to slide-out assemblies for use in such vehicles, which change the available interior space of the vehicle according to the operation of those assemblies by vehicle users.

A wide variety of “RVs” are known, including both motorized and towable vehicles, such as motorhomes, travel trailers, fifth wheel trailers, toy haulers, truck campers, and pop-up campers. “Slide-out” rooms or room portions have been used in many different types of RVs. The assemblies for slide-outs provide mechanisms and arrangements for moving a portion of a room into and out of the main body of the RV, so that the floorplan of the RV can change and/or the amount of available interior space of the vehicle can be changed. Typically, the slide-out assembly is moved into the RV when the vehicle is in motion, and then moved outwardly, to extend from the RV, when the vehicle is parked and set up for occupancy. A given RV can have one or more slide-out assemblies, and even slide-out assemblies mounted within slide-out assemblies.

Previously, slide-out assemblies for RVs have used a rectangular floor with left and right side walls extending vertically upward from the floor, and a roof portion covering the sides. One or more drive mechanisms, either electric or hydraulic, have been used to slide the rectangular box formed thereby, inward and outward with respect to a primary side wall of the RV. Motion of the slide-out assemblies in that regard has been merely linear, preferably straight out and in, perpendicular to the RV side wall, so that the slide-out assembly does not scrape or mark any adjacent interior walls or structures of the RV, and so that a weather-tight seal can be formed and/or maintained between the outwardly extended slide-out assembly and the rest of the RV. Where separate motors or drive mechanisms have been used on each side of the slide-out assemblies, these motors have typically needed to be synchronized in their motion in order to avoid jamming of the slide-out assembly on the tracks used to support the assembly as it moves in and out of the RV.

Previously, slide-out assemblies have needed to take up a significant amount of usable floor space inside of the RV when the slide-out assemblies are retracted into the RV. For example, in the case of motorhomes, when the slide-out assembly is positioned behind the vehicle driver seat, this has caused limitations in visual and/or physical access to the vehicle by the driver, until the slide-out assembly is extended from the vehicle. Also, while RV floorplans can be quite varied and provide home-like environments for occupants, prior slide-out assemblies have allowed only rectangular additions to the floorplans.

Previously, slide-out assemblies have used substantially flat or linear rooflines, often with awnings or covers to facilitate run-off of fluids, such as rain, from the slide-out assembly and reduce the risk of leakage into the RV. Some RVs have used linearly pitched or centrally peaked rooflines to facilitate fluid run-off, but weather tight sealing and manufacturing of such slide-out assemblies can become more complicated and expensive.

### OBJECTIVES OF THE INVENTION

Accordingly, an objective of the present invention is to provide improved slide-out assemblies for RVs. These improvements include providing slide-out mechanisms which:
a. are inexpensive to make and reliable in operation,
b. increase the usable floor space, and visual and physical access to the RV when the slide-out mechanism is retracted into the RV,
c. increase the optimization of RV floorplans when the slide-out mechanism is extended outward from the RV,
d. are less likely to leak fluid into the RV, and
e. increase the aesthetic appeal of the RV.

### SUMMARY OF THE INVENTION

These and other objectives of the present invention are achieved by the provision of slide-out assemblies having non-rectangular floors, wherein one side wall of the slide-out assembly can be extended outward further from the vehicle than the other side wall, and wherein the movement of the slide-out assembly into and out of the RV includes pivotal motion and/or motion along a non-linear path. In addition, slide-out assemblies according to the present invention include a curved roofline to facilitate fluid run off.

Other objects, advantages, and novel features of the present invention will become readily apparent from the following drawings and detailed description of certain preferred and alternative embodiments.

### BRIEF DESCRIPTION OF THE DRAWINGS

FIG. 1 shows a top plan view of an RV with the slide-out assembly fully retracted therein.

FIG. 2 shows a top plan view of an RV with the slide-out assembly partially extending outward from the RV.

FIG. 3 shows a top plan view of an RV with the slide-out assembly fully extended outward from the RV.

FIG. 3A shows a top plan view of an RV with the slide-out assembly fully extended outward from the RV at an alternative angle with respect to the RV side wall.

FIG. 4 shows a top plan view of an RV with an alternative slide-out assembly fully retracted therein.

FIG. 5 shows a side plan view of an RV with a slide-out assembly having a curved roofline.

FIG. 6 shows a side plan view of an RV with a slide-out assembly having an alternative curved roofline.

### DETAILED DESCRIPTION OF PREFERRED EMBODIMENTS

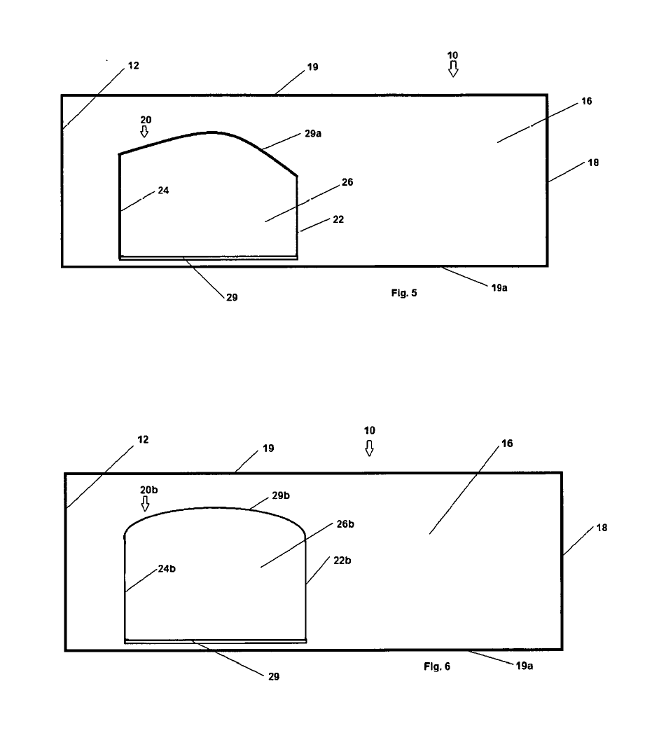

The drawings show plan views of preferred embodiments of the present invention as applied to a generic RV 10. The present invention is applicable to a wide variety of RV types, both motorized and towable. The slide-out assembly 20 of the present invention can be placed in a variety of locations within RV 10 and at multiple locations, according to conventional considerations and floorplan designs. The slide-out assembly 20 of the present invention can also be used inside of conventional slide-out assemblies, so as to have a slide-out within a slide-out. Further, the slide-out assembly 20 of the present invention can be used within a slide-out assembly of the same type, so as to have multiple, non-rectangular slide-out floor sections. Also, FIGS. 5 and 6 are not drawn to scale with FIGS. 1-4, and the slide-out assemblies of FIGS. 5 and 6 are not necessarily using the slide-out assembly features as shown in FIGS. 1-4.

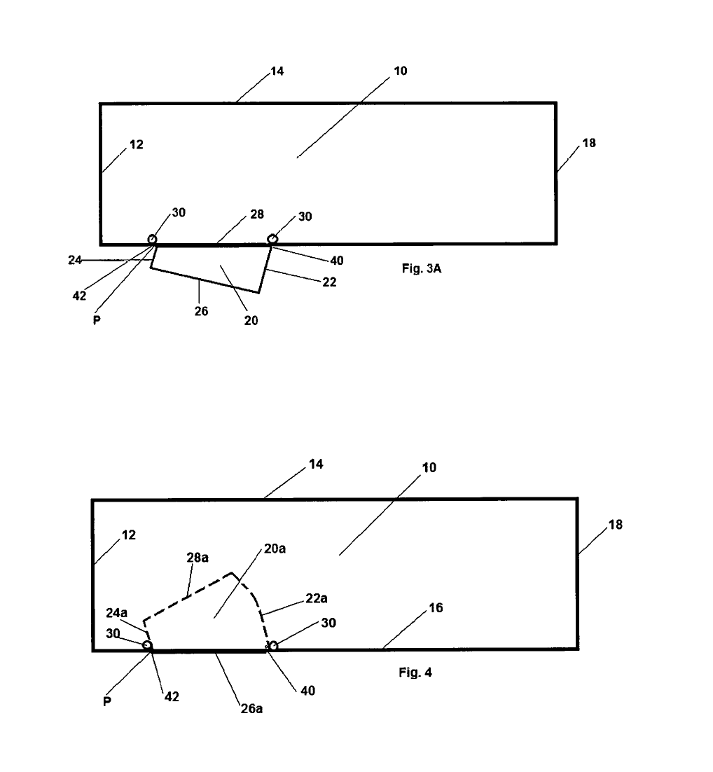

The following features are illustrated in the drawings:
a RV 10, having a front wall 12, side walls 14 and 16, and a rear wall 18, the interior of the RV being defined within these walls, and roof 19 and bottom 19a,
a slide-out assembly 20, having a first side wall 22, a second side wall 24, a front 26 a back 28, a floor 29, and alternative roofs 29a and 29b.
drive motors 30 and related apparatus, of a conventional nature (either electric or hydraulic), except as described herein,
pivot point P, as described further herein, and
wall seals 40 and 42.
   It should be noted that, as used herein, the “back” of the slide-out assembly is a locational reference. There is typically no back wall for a slide-out assembly, in contrast to the front and sides of the slide-out assembly typically having vertically extending walls associated therewith, extending upward from the floor of the slide-out assembly. Instead, the back of a slide-out assembly is usually open, so as to allow full access to the slide out by the user. Also, in FIG. 4, the corresponding elements of alternative slide-out assembly 20a are shown as first wall 22a, second wall 24a, front 26a and back 28a. Similarly, in FIG. 6, the corresponding elements of another alternative slide-out assembly 20b as shown as first wall 22b, second wall 24b, and front 26b.

In operation, drive motors 30 (and/or such other motive apparatus as may be desirable in a given application) are arranged to move the slide-out assembly into and out of RV 10. Where a single drive motor is used, separate drive apparatus 30 are connected to that motor and are used to direct the separate motion of each side 22 and 24 of the slide-out assembly.

The slide-out assembly of the present invention provides a non-rectangular floor 29 (having floor edges corresponding to the front, back and each side of the slide-out assembly), such that side wall 22 is longer than slide wall 24. In alternative embodiments of the present invention, the left side wall can be longer or the right side wall can be longer. The longer side wall 22 will extend further outward from side wall 16 of RV 10 when the slide-out assembly is fully extended out of RV 10. As seen by comparing the plan view of FIGS. 1 and 4, floor 29 can be any desired non-rectangular shape, both polygonal or incorporating one or more curved sides. A distinguishing feature of the present invention is that one side of that floor, corresponding to a side wall extendable from the vehicle, is longer than another side extendable from the vehicle. Thus, the movement paths of the side walls is not the same. Drive motors or drive apparatus 30 thus need not be synchronized for identical drive movement, at least with respect to the portion of the movement of the side walls which is not identical.

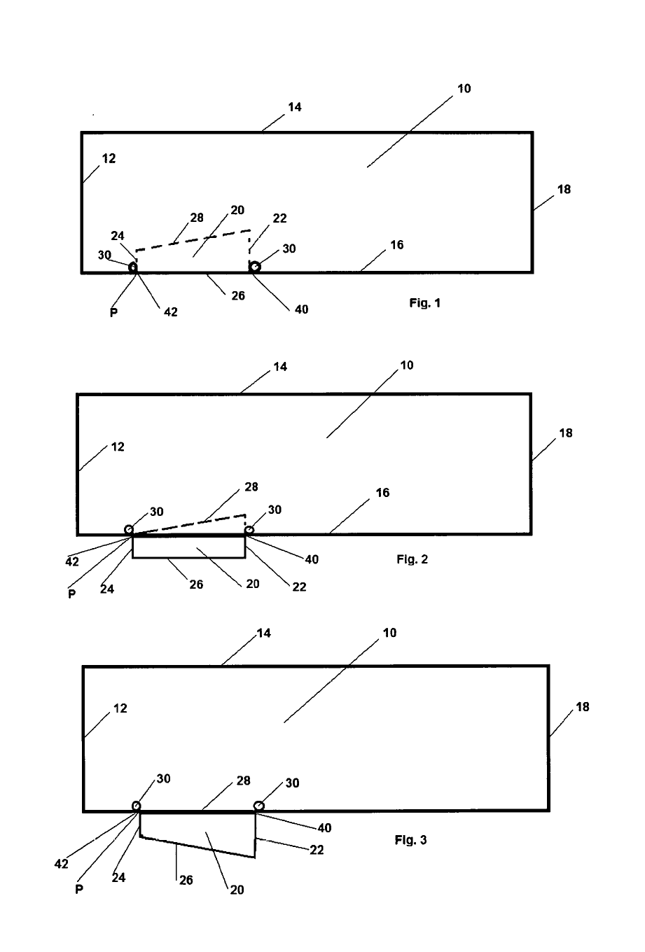

For example, as shown by comparing FIGS. 1 and 2, where the floor is trapezoidal (or quadrilateral or polygonal) in shape, during the first portion of the extension of slide-out assembly 20 from RV 10, the movement paths of side walls 22 and 24 is the same, in parallel. However, as shown by comparing FIGS. 2 and 3, as side wall 24 reaches its limit and then abuts against RV side wall 16, side wall 22 continues to move outward from RV side wall 16.

The present invention accommodates this continued movement by allowing the slide-out assembly to rotate or pivot at location P. Seal 42 is formed to accommodate this pivoting by the use of conventional materials and seal structural configurations. While it is not apparent from the scale of the drawings, this continued motion of side wall 22 may necessarily be in the form of an “arc” or curve (particularly if side wall 22 is completely flat or straight in cross-section), such that the opening in RV side wall 16 used to accommodate the slide-out assembly is slightly larger than would otherwise be needed if the slide-out assembly was moving merely perpendicularly outward. This can allow the slide-out assembly to achieve substantially the orientation shown in FIG. 3, when fully extended. However, given the normal variances in drive motor synchronization and production tolerances, that opening may not be significantly larger than those used in prior RV construction. In either event, seal 40 is formed to accommodate this extra dimension by use of conventional materials and seal structural configurations.

In addition, if side wall 24 is perpendicular to RV side wall 16 when the slide-out assembly is retracted within RV 10, the pivoting motion of the slide-out assembly permits side wall 24 to assume a non-perpendicular orientation with respect to RV side wall 16 when the slide-out assembly is fully extended outwardly from RV 10, as shown in FIG. 3A. In a given application of the present invention, many desired perpendicular or non-perpendicular extended orientations of those wall can be accommodated, as may be desired for a given interior floorplan and/or for enhanced exterior aesthetic appearance.

Also, if closer opening dimensions or tolerances for openings in RV side wall 16, and/or if perpendicular extension of side wall 24 is desired, side wall 22a can be formed with a curved or bent section, as shown in FIG. 4. Further, even if a primarily rectangular floorplan assembly for slide-out assemblies is desired, use of the pivoting feature of the present invention can better accommodate minor dimensional variances in production of slide-out assemblies which could otherwise require more costly synchronization of the drive motors, or result in binding of the slide-out during its motion cycle and/or leakage past the side wall seals.

The present invention further provides an improved roof arrangement for slide-out assemblies, as shown in FIGS. 5 and 6. Roofs 29a and 29b are curved from the side elevational perspective, rather than being flat or linear with an angled peak or bend. This structure not only provides enhances aesthetic appeal, it improves the fluid run off characteristics of the slide-out assembly, even without a cover or awning. A continuous curve, for example, can avoid the use of peak joints and additional seals, providing greater reliability and avoiding production cost increases. With the present invention, the roofline curvature need not be symmetric from one side to the other (as shown, for example, in FIG. 6). Rather, asymmetric rooflines can be used, where the fluid run off is directed to a lower side wall (as shown, for example, in FIG. 5).

Although the present invention has been shown and described herein with respect to certain preferred embodiments and alternative configurations, those were by way of illustration and example only. For example, the present invention has been described with respect to RV applications. However, slide-out assemblies can be used in cargo trailers, as well as in over the road trucks and other vehicles. The present invention is readily employed in those applications as well. Accordingly, the scope of the present invention is intended to be limited only by the terms of the appended claims.

What is claimed is:

1. A slide-out assembly for use with a vehicle, wherein the slide-out is movable into and outward from that vehicle so as to change the interior space available in that vehicle, comprising:
a first wall and a second wall, and
the first wall extends outward further from the vehicle than the second wall when the slide-out assembly is fully moved outward from that vehicle.

2. The slide-out assembly according to claim 1, where in the first wall and the second wall are moved with respect to the vehicle by separate driving apparatus.

3. The slide-out assembly according to claim 2 wherein the first wall and the second wall are driven by motors that are not synchronized for at least a portion of the movement paths of the first and second walls.

4. The slide-out assembly according to claim 1 wherein the first wall and the second wall have different movement paths, at least in part, when moving into and outward from the vehicle.

5. The slide-out assembly according to claim 1 wherein the second wall pivots with respect to the vehicle for at least a portion of the outward movement of the first wall with respect to that vehicle.

6. A slide-out assembly for use with a recreational vehicle, wherein the slide-out is movable into and outward from that vehicle so as to change the interior space available in that vehicle, comprising:
a floor,
a first wall and a second wall, formed at opposing sides of the floor,
a roof joining the first and second walls, and extending over the floor, and
the roof having different elevations from the floor between the first and second walls, so as to facilitate fluid run off of the roof, along a curvilinear roofline.

7. The slide-out assembly according to claim 6 wherein the roof is arched so as to have a higher elevation between the first and second walls than it has at the junctions with the first and second walls.

8. The slide-out assembly according to claim 6 wherein the first wall has a shorter height than the second wall, such that the roof is inclined downwardly toward the first wall.

9. The slide-out assembly according to claim 8 wherein the roof is arched so as to have a higher elevation between the first and second walls than it has at either junction with the first or second walls.

10. A slide-out assembly for use with a vehicle, wherein the slide-out is movable into and outward from that vehicle so as to change the interior space available in that vehicle, comprising:
a floor having front edge, a back edge, and first side edge joining the front edge with the back edge, and a second side edge joining the front edge with the back edge, and
the length of the first side edge is substantially longer than the length of the second side edge.

11. The slide-out assembly according to claim 10, further comprising:
a first side wall and a second side wall, mounted adjacent the first and second side edges, respectively, and each extending vertically from the floor, and
the first side wall extends outward further from the vehicle than the second wall when the slide-out assembly is fully moved outward from that vehicle.

12. The slide-out assembly according to claim 11 wherein the second side wall pivots with respect to the vehicle for at least a portion of the outward movement of the first side wall with respect to that vehicle.

13. The slide-out assembly according to claim 11, further comprising:
a roof joining the first and second side walls, and extending over the floor, and
the roof having different elevations from the floor between the first and side second walls, so as to facilitate fluid run off of the roof, along a curvilinear roofline.

14. The slide-out assembly according to claim 10 having the ornamental design for a slide-out assembly, substantially as shown and described in the Figures.

15. The ornamental design for a slide-out assembly roofline of claim 14, substantially as shown in FIG. 5.

16. The ornamental design for a slide-out-assembly roofline of claim 14, substantially as shown in FIG. 6.
